(19) United States
(12) Patent Application Publication
(10) Pub. No.: US 2018/0161716 A1
(43) Pub. Date: Jun. 14, 2018

(54) AIR PURIFIER BASED ON FILTER ANTI-COUNTERFEITING IDENTIFICATION

(71) Applicant: FOSHAN SHUNDE APOLLO AIR-CLEANER CO., LTD., Foshan (CN)

(72) Inventors: Qing'en Li, Foshan (CN); Yaowu Zhong, Foshan (CN); Zhengxiang Feng, Foshan (CN); Xiaochun Pi, Foshan (CN)

(21) Appl. No.: 15/891,364

(22) Filed: Feb. 7, 2018

Related U.S. Application Data
(63) Continuation of application No. PCT/CN2014/092553, filed on Nov. 28, 2014.

(30) Foreign Application Priority Data
Nov. 3, 2014 (CN) 201410614057.0

(51) Int. Cl. B01D 46/00; B01D 46/42; B01D 46/10

(52) U.S. Cl. CPC B01D 46/0086; B01D 46/10; B01D 46/429

(57) ABSTRACT

Disclosed is an air purifier based on filter anti-counterfeiting identification, comprising a purifier body (1) in which control circuitry and a purifying chamber are provided; a filter (2) is arranged in the purifying chamber; the filters (2) are paired and coupled with the purifier body (1) via an identification unit; the identification unit comprises an identification chip configured on the filter (2) and an identifier configured on the purifier body (1); the identifier is connected with the control circuitry; the control circuitry is powered on and starts to operate until the pairing between the identification chip and the identifier succeeds. The identification process can identify multiple objects without manual intervention. Moreover, it responds quickly and no mechanical malfunction will happen. Thus, the air purifier can operate under harsh environment and serve for a long time. In this manner, counterfeits can be effectively prevented and quality of products can be guaranteed.

### CROSS-REFERENCE TO RELATED APPLICATIONS

The present application is a Continuation Application of PCT application No. PCT/CN2014/092553 filed on Nov. 28, 2014, which claims the priority of Chinese Patent Application No. 201410614057.0 filed on Nov. 3, 2014. The contents of the above are hereby incorporated by reference.

### FIELD OF THE INVENTION

The present invention relates to air purifiers, in particular, to an air purifier based on filter anti-counterfeiting identification.

### BACKGROUND OF THE INVENTION

Haze pollution in a variety of cities has been rising in recent years, so air purifiers are widely used in a myriad of families. However, filters of air purifiers need to be replaced at regular intervals so as to guarantee the filtering effect. Due to the success of market sales of this kind of air purifiers, a plenty of counterfeit filters arise on the Internet. These counterfeit filters have low price, poor workmanship and unguaranteed quality. Filtering performance of these counterfeit filters are significantly inferior to the original filters so they cannot achieve the effect of air purification and their service life is short, which will hurt consumers' interest and reputation of manufacturers of overall air purifiers.

### SUMMARY OF THE INVENTION

In order to prevent counterfeit filters from widely spreading, the present invention provides an air purifier based on filter anti-counterfeiting identification. The air purifier will not be powered on or function well until filters therein pass the anti-counterfeiting identification, whereby purification quality is ensured.

The technical solution provided in the present invention for the preceding purpose is as follows:

an air purifier based on filter anti-counterfeiting identification, comprising a purifier body in which control circuitry and a purifying chamber are provided; at least one filter is arranged in the purifying chamber; wherein the filter is paired and coupled with the purifier body via an identification unit; the identification unit comprises an identification chip configured on the filter and an identifier configured on the purifier body; the identifier is connected with the control circuitry; the control circuitry is powered on and starts to operate until the pairing between the identification chip and the identifier succeeds; all the identification chips on the filters should be paired with the identifier successfully, otherwise the air purifier cannot start; the identification chip and the identifier operate independently so the identification unit can be provided additionally onto existing air purifiers, and thereby they can be equipped the function of filter anti-counterfeiting identification without structural modification. This solution provides high stability at low cost and is capable of meeting consumer demands and subsequent function extension demands.

Preferably, the identification chip is an electronic label and the identifier is a reading module; the reading module exchanges data with the electronic label via wireless signals to achieve identification and pairing.

Preferably, the electronic label comprises a contactless IC and a radio frequency (RF) antenna around the contactless IC; the contactless IC is a radio frequency identification (RFID) chip provided with a data memory and a timer; operating frequency of the contactless IC is 13.56 MHZ; data in the data memory can be added, modified, or deleted time after time to facilitate information update and to record data such as information of the manufacturer, date of manufacture, check code and the like.

Preferably, the timer built in the contactless IC is configured to send a stop command to the air purifier once predetermined service time of the filter is out, i.e., the timer can record service time of the filter in real time and when it reaches a time limit, the contactless IC sends a signal to the control circuitry to turn power off and stop the air purifier.

Preferably, the RF antenna is one of a printed antenna, an etching antenna and a winding antenna. A variety of antennas made of different materials can be selected from on the basis of a material of the filter so as to guarantee transmission stability of the RF signals.

By using contactless automatic identification technique, the identification of the filter is automatically conducted when a filter is installed into the purifier body. The reading module sends out a RF signal via a built-in antenna, and then the electronic label receives a reading command via a RF antenna and replies with a RF signal, transmitting information of the product to the reading module, and then verification of password and pairing is carried out, whereby the automatic identification is realized.

Preferably, the RF antenna surrounds the contactless IC in a round, triangular, square, oval or irregular shape.

Further preferably, a line width of the RF antenna ranges from 0.5 mm to 10 mm.

The electronic label is encapsulated to form an individual module to be embedded in the filter. Due to its small volume, the electronic label can be encapsulated and embedded into a product easily, being convenient to use.

Preferably, a distance between the reading module and the electronic label of each layer of filter is within 10 cm and the reading module can read electronic labels on a plurality of filters simultaneously. The RF signal of the electronic label has strong penetrating power; and thereby it can pass through the nonmetallic or nontransparent materials such as papers, woods, plastics etc. so as to support penetrating communication.

Preferably, the filter comprises a frame and a filtering layer fixed on the frame, wherein the filter layer comprises a first filtering sub-layer for removing the air contaminant and a second filtering sub-layer for removing solid particulate matters.

The electronic labels are arranged on the frames of the filters individually and the filters are arranged in the purifying chamber. Combined filtration can be implemented by using multiple filters with different structures. The present invention utilizes filters mentioned above as an embodiment and thereby long-lasting and effective purification can be achieved. Meanwhile, the ventilation of the filter will not be affected and effective filtration can be achieved.

Preferably, the purifier body is provided with a blower, the control circuitry is connected to and drives the blower to operate and to allow air to pass through the filter so that filtration thereof is implemented.

The advantages are as follows:

The air purifier uses the identification unit as a verification device so as to distinguish original filters from counterfeits. By utilizing the RFID technique, a filter can be identified and relevant data can be acquired automatically for the purpose of identification. Based on the result of identification, the air purifier is commanded to start or not and feedback of the information about filters and its operation status can be sent to the air purifier. The identification process can identify multiple objects without manual intervention. Moreover, it responds quickly and no mechanical malfunction will happen. Thus, the air purifier can operate under harsh environment and serve for a long time. In this manner, counterfeits can be effectively prevented and quality of products can be guaranteed.

### BRIEF DESCRIPTION OF DRAWINGS

Embodiments of the present invention are further explained clearly as follows in conjunction with figures.

FIG. 1 is an exploded view of the air purifier according to the present invention.

FIG. 2 is a schematic of the electronic label and reading module according to the present invention.

### DETAILED DESCRIPTION OF PREFERRED EMBODIMENTS

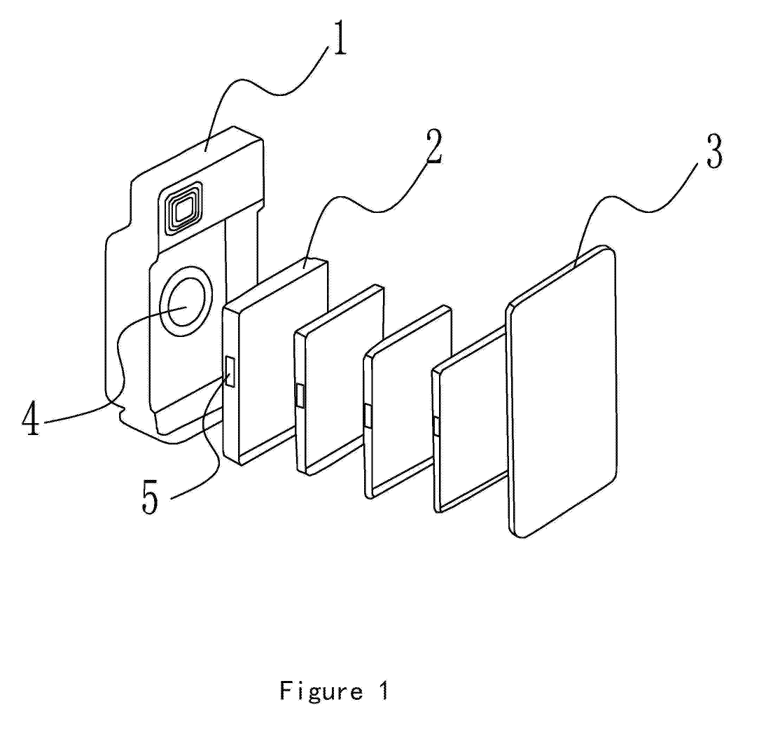

As shown in FIG. 1, the present invention provides an air purifier based on filter anti-counterfeiting identification, comprising a purifier body 1 in which control circuitry and a purifying chamber are provided for accommodating filters 2 therein; one or more filters 2 are arranged in the purifying chamber orderly; the purifier body 1 is also provided with an air purifying panel 3 covering the purifying chamber. The filters 2 are paired and coupled with the purifier body 1 via an identification unit. The identification unit comprises identification chips individually configured on the filters 2 and an identifier configured on the purifier body 1. The identifier is connected with the control circuitry. When an identification chip of a filter 2 fails to be paired with the identifier or a filter 2 without an identification chip is installed, the identifier turns the control circuitry off and prevents the air purifier from operating normally. The control circuitry is powered on and activates the air purifier to operate normally until a filter with an identification chip is installed and the pairing between the identification chip and the identifier succeeds. In order to achieve other anti-counterfeiting purposes, all identification chips on these filters should be simultaneously paired with the identifier successfully, otherwise the air purifier cannot start.

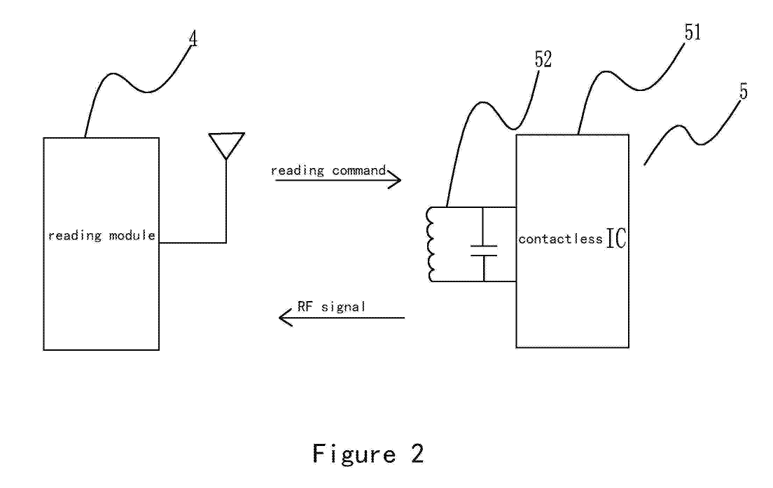

As shown in FIG. 2, the present invention utilizes a contactless RF automatic identification technique which is adapted for short-distance contactless identification as a preferred embodiment of the identification unit. In particular, the identification chip is an electronic label 5 and the identifier is a reading module 4. The reading module 4 is a RFID reading module being connected to the control circuitry. The electronic label comprises a contactless IC51 and a RF antenna 52 around the contactless IC 51. The contactless IC 51 is a RF identification chip and its operating frequency is 13.56 MHZ. The contactless IC51 is provided with a data memory. The electronic label 5 does not have an internal power supply and its internal integrated circuit is driven by the electromagnetic wave received from the reading module 4 with RF identification function. When the electronic label 5 receives a RF signal with enough strength, it will send data to the reading module 4. The data include not only one unique ID identification number but also the data stored in the memory of the contactless IC 51 in advance. The data stored in the memory can be added, modified or deleted time after time so as to facilitate the information update and to record data such as information of the manufacturer, date of manufacture, check code and the like. In order to prompt the utility, a timer is provided in the contactless IC 51 and records the service time of the filter in real time and when it reaches a predetermined time limit, the contactless IC sends a stop command to the reading module 4, by which the command is transmitted to the control circuitry to turn power off and stop the air purifier until the filter 2 is replaced with a new one.

The principle of the RF identification is as follows: the reading module 4 sends the electronic label 5 a set of electromagnetic waves with constant frequency which is the same as the frequency of the LC series resonant circuit in the contact IC51. Being stimulated by the electromagnetic waves, the LC series circuit resonates whereby charges accumulate in a capacitor. A unidirectional pump is connected to the other end of the capacitor and transfers the charges of the capacitor to another capacitor where the charges accumulate. When the charges accumulates to 2V, the capacitor will act as a power supply and provide working voltage to other circuits so as to enable the contactless IC51 to send data or to receive data from the reading module 4.

In particular, the process of the paring connection is as follows: when the filter 2 is installed into the purifier body 1, the purifier automatically conducts identification. The reading module 4 sends out a RF signal via a built-in antenna, and then the electronic label 5 receives the reading command via the RF antenna 52 and replies with a RF signal, transmitting information of the product to the reading module 4. Meanwhile, verification of password and pairing is carried out to verify the consistency between the information of the product and the verifying password, and thereby the automatic identification is realized. In this manner, the identification of multiple objects can be conducted at one time without manual intervention. Moreover, it responds quickly and no mechanical malfunction will happen. Thereby, the air purifier can operate under harsh environment and serve for a long time. The electronic label and the reading module 4 utilized in the present invention operate independently and are adapted to be attached and detached easily. Because of its small volume, the electronic label 5 can be easily encapsulated. Thus, the electronic label 5 can be encapsulated as an individual module to be embedded on the filter. The two functional elements, i.e. the electronic label 5 and the reading module 4 can be added to an existing common air purifier so that it can be updated to an air purifier with the function of filter 2 anti-counterfeiting identification, which is very convenient to operate.

Preferably, the RF antenna 52 is one of a printed antenna, an etching antenna and a winding antenna. The RF antenna surrounds the contactless IC in a round, triangular, square, oval or irregular shape. The line width of the RF antenna ranges from 0.5 mm to 10 mm. A variety of RF antennas 52 made of different materials can be selected from on the basis of the material of the filter 2 so as to guarantee transmission stability of RF signals.

Preferably, a distance between the reading module 4 and the electronic label 5 of each layer of filter 2 is within 10 cm, with in this distance, the reading module 4 can read the electronic labels 5 on the plurality of filters 2 simultaneously. The RF signal of the electronic label 5 has high penetrating power, and thereby it can pass through the nonmetallic or nontransparent materials such as papers, woods, plastics and so on to support penetrating communication even being covered.

An embodiment of the filter 2 according to the present invention comprises a frame and a filtering layer fixed on the frame, wherein the filtering layer comprises a first filtering sub-layer for removing the air contaminant and a second filtering sub-layer for removing solid particulate matters. This structure of the filtering layer can reach long-lasting and effective purification, besides, the ventilation of the filter will not be affected and good filtration effect can be achieved. Moreover, the electronic label is arranged on the frame of the filter, with in the range of RF identification. In order to prompt the purification effect, the purifier body 1 is provided with a blower. The control circuitry is connected to and drives the blower to operate and to allow air to pass through the filter and to undergo filtration.

It should be noted that, the embodiments and features of these embodiments can be combined mutually on the condition of no confliction.

Hereinbefore are only preferred embodiments of the present invention, which are only used to facilitate the understanding of the present invention rather than to limit the structure of the embodiments mentioned above. Based on the embodiments of the present invention, all the other embodiments obtained by the skilled in the art being capable of achieving the effect of the present invention are within the protection scope of the present invention.

What is claimed is:

1. An air purifier based on filter anti-counterfeiting identification, comprising a purifier body in which control circuitry and a purifying chamber are provided; a filter is arranged in the purifying chamber; wherein the filter is paired and coupled with the purifier body via an identification unit; the identification unit comprises an identification chip configured on the filter and an identifier configured on the purifier body; the identifier is connected with the control circuitry; the control circuitry is powered on and starts to operate until the pairing between the identification chip and the identifier succeeds.

2. The air purifier based on filter anti-counterfeiting identification according to claim 1, characterized in that the identification chip is an electronic label and the identifier is a reading module; the reading module exchanges data with the electronic label via wireless signals to achieve identification and pairing.

3. The air purifier based on filter anti-counterfeiting identification according to claim 2, characterized in that the electronic label comprises a contactless IC and a RF antenna around the contactless IC; the contactless IC is a RF identification chip provided with a data memory and a timer.

4. The air purifier based on filter anti-counterfeiting identification according to claim 3, characterized in that the timer built in the contactless IC may send a stop command to the air purifier once predetermined service time of the filter is out.

5. The air purifier based on filter anti-counterfeiting identification according to claim 3, characterized in that the RF antenna is one of a printed antenna, an etching antenna and a winding antenna.

6. The air purifier based on filter anti-counterfeiting identification according to claim 3, characterized in that the RF antenna surrounds the contactless IC in a round, triangular, square, oval or irregular shape.

7. The air purifier based on filter anti-counterfeiting identification according to claim 6, characterized in that a line width of the RF antenna ranges from 0.5 mm to 10 mm.

8. The air purifier based on filter anti-counterfeiting identification according to claim 2, characterized in that the electronic label is encapsulated to form an individual module to be embedded in the filter.

9. The air purifier based on filter anti-counterfeiting identification according to claim 2, characterized in that a distance between the reading module and the electronic label of the filter is within 10 cm and the reading module can read the electronic label on the filter simultaneously.

10. The air purifier based on filter anti-counterfeiting identification according to claim 1, characterized in that the filter comprises a frame and a filtering layer fixed on the frame, wherein the filtering layer comprises a first filtering sub-layer for removing the air contaminant and a second filtering sub-layer for removing solid particulate matters.

11. The air purifier based on filter anti-counterfeiting identification according to claim 3, characterized in that the electronic label is encapsulated to form an individual module to be embedded in the filter.

12. The air purifier based on filter anti-counterfeiting identification according to claim 4, characterized in that the electronic label is encapsulated to form an individual module to be embedded in the filter.

13. The air purifier based on filter anti-counterfeiting identification according to claim 2, characterized in that the filter comprises a frame and a filtering layer fixed on the frame, wherein the filtering layer comprises a first filtering sub-layer for removing the air contaminant and a second filtering sub-layer for removing solid particulate matters.
